(19) United States
(12) Patent Application Publication
(10) Pub. No.: US 2010/0013672 A1
(43) Pub. Date: Jan. 21, 2010

(54) PHOTOGRAPHIC MULTIPLE VEHICULAR TRAFFIC TICKET ISSUANCE SYSTEM

(76) Inventor: Mel Francis P. Quintos, III, Fairfax Station, VA (US)

Correspondence Address: KRATZ, QUINTOS & HANSON, LLP, 1420 K Street, N.W., Suite 400, WASHINGTON, DC, 20005, US

(21) Appl. No.: 12/175,110

(22) Filed: Jul. 17, 2008

(51) Int. Cl. G08G 1/01

(52) U.S. Cl. 340/936

(57) ABSTRACT

A photographic traffic ticket issuance system or an automatic traffic ticket issuance system, preferably used within a police vehicle; the police vehicle, either mobile or stationary, is preferably used with a photographic device. The system includes a processing system within the police vehicle, which detects and determines that a vehicle is traveling at a speed that is beyond the speed limit. Information processed within the processing system and transmitted to a police station for processing can contain, for example, the specific information on the vehicle, its owner, the speed of the vehicle, the videotaped and/or photographed information of the vehicle 103, its license plate (or tag), or the like, in any combination. Upon receiving the information from the processing system of the police vehicle, the police station processes the information, the processing including issuing and transmitting of a traffic ticket, either via the post office or electronically, to the vehicle owner's home.

### BACKGROUND OF THE INVENTION

1. Field of the Invention

This invention is generally directed to a photographic traffic ticket issuance system or an automatic traffic ticket issuance system, preferably used within a vehicle. The invention, either mobile or stationary, is preferably used with a photographic device.

2. Discussion of the Relevant Art

When vehicles unlawfully speed, radar systems are often used by police to detect the offense, and drivers of the speeding vehicles are apprehended and issued traffic tickets. However, this procedure is limited to catching or apprehending a single driver, instead of a multiple number of drivers. In reality, many drivers drive their vehicles well beyond the speed limit in a stretch of road or highway without fear of being caught. This situation presents a dangerous environment for those drivers who drive their vehicles within the speed limit.

Also used by police to apprehend violators of traffic laws are cameras installed near traffic lights. It is known that when such cameras are used, photographs of vehicle license plates are taken of vehicles that run through a red light, and traffic tickets are issued and mailed to the homes of the violators, along with accompanying photographs of their license plates. However, such cameras are fixed and not mobile; and thus, such cameras are only effective for catching vehicles that run through a red light, and not used for catching vehicles that speed beyond prescribed speed limits.

### SUMMARY OF THE INVENTION

When a processing system within a police vehicle detects and determines that a vehicle is traveling at a speed that is beyond the speed limit with the use of a radar system, information is transmitted from the police vehicle to a police station. The information transmitted to the police station can contain, for example, the specific information on the vehicle, its owner, the speed of the vehicle, the videotaped and/or photographed information of the vehicle 103, its license plate (or tag), or the like, in any combination. Upon receiving the information from the processing system of the police vehicle, the police station processes the information, the processing including issuing and transmitting of a traffic ticket, either via the post office or electronically, to the vehicle owner's home. With this structural arrangement and process of the invention, multiple traffic tickets may be issued rapidly and efficiently, without necessarily stopping the moving vehicle and perhaps even avoiding endangering the safety of a police officer handling the radar system within his police vehicle.

### BRIEF DESCRIPTION OF THE DRAWINGS

FIG. 1 is a schematic sketch showing the photographic traffic ticket issuance system or the automatic traffic ticket issuance system of this invention; and

FIG. 2 is a block box diagram of the photographic traffic ticket issuance system or an automatic traffic ticket issuance system of this invention.

### DETAILED DESCRIPTION OF THE PREFERRED EMBODIMENTS

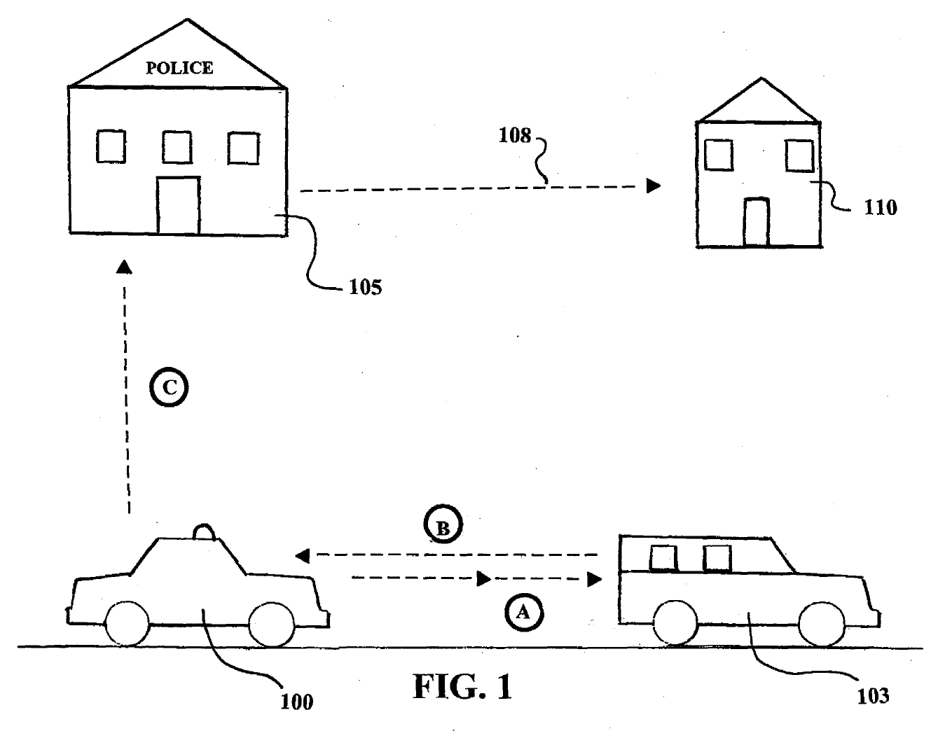

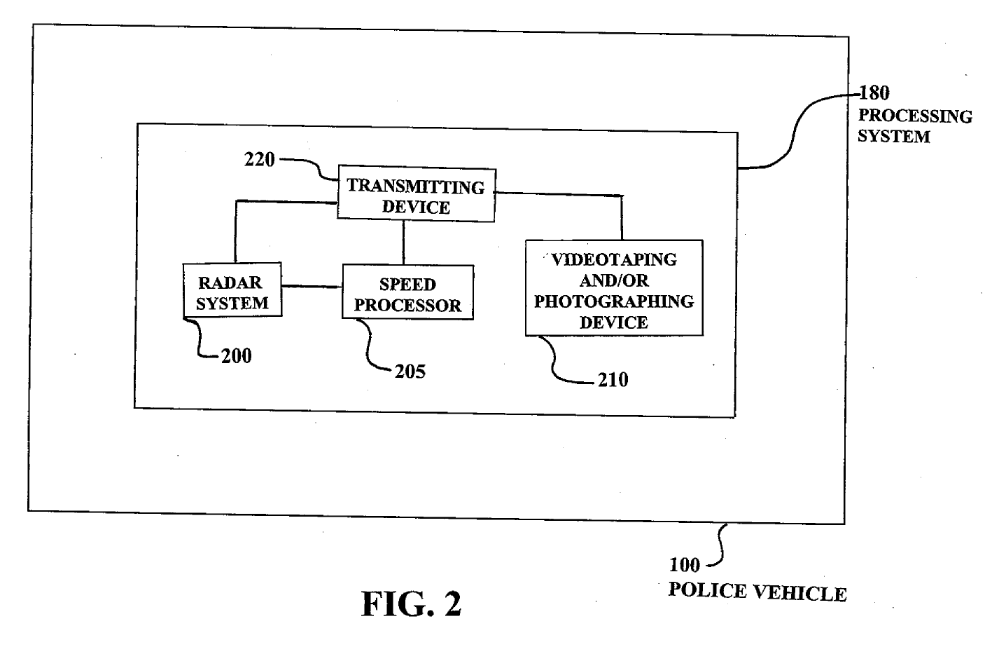

As shown in FIG. 1, a police vehicle 100, which employs a radar system 200 (shown in FIG. 2), directs its radar gun (not shown) towards a moving vehicle 103. The signal transmitted from the police vehicle I 00 towards the moving vehicle 103 is generally labeled as signal A. The signal received by the radar system 200 of the police vehicle 100 from the moving vehicle 103 is generally labeled as signal B.

As illustrated in FIG. 2, inside the police vehicle 100 is a processing system 180. Within this processing system 180 are at least the radar system 200 for monitoring the speed of at least the vehicle 103, and a speed processor 205, which receives the information from the radar system 200, for determining whether the speed of the vehicle 103 surpasses the speed limit. At least one of a videotaping and/or photographing device 210 is further contained within the processing system 180 of the police vehicle 103. The videotaping and/or photographing device 210 is for videotaping and/or photographing the vehicle 103 (including the license plate or tag thereof).

When the radar system 200 of the police vehicle 100 detects the speed of the moving vehicle 103, and determines that the detected speed is beyond the prescribed speed limit for the road traveled on, the radar system 200 of the police vehicle 100, connected to the processing system 180 that processes information (e.g., identifying the license plate of the moving vehicle 103 or the like) then transmits information, including vehicle identification and vehicle speed, to a transmitting device 220, and to (in the form of another signal generally labeled signal C) a police station 105 or the like for processing. The police station 105 thereafter processes the received signal C, indicating the, for example, vehicle identification and vehicle speed. The received signal C is thereafter processed to the extent that a traffic ticket (in the form of, for example, paper or e-mail) 108 is issued and mailed to the home 110 of the owner of the moving vehicle 103. With this structural arrangement and process, multiple traffic tickets may be issued rapidly and efficiently, without necessarily stopping the moving vehicle 103 and perhaps even avoiding endangering the safety of a police officer handling the radar system within his police vehicle 100.

The police vehicle 100, which can be either stationary or moving, has also contained within the processing system 180, a device for either videotaping or photographing the, for example, vehicle 103. When the radar system of the processing system detects that the speed of the vehicle 103 is beyond the speed limit prescribed for the road or highway on which the vehicle is traveling on, the vehicle 103 is videotaped or photographed, and recorded. The information (videotape or photograph of the vehicle 103 with its license plate or tag) is then transmitted to the transmitting device 220 for subsequent transmission (shown also as signal C) to the police station 105 for processing.

With respect to the signal B, discussed above, this signal B may be processed within the processing system 180 so as to be able to specifically identify the, for example, vehicle and/or its owner.

When the signal B is detected and determined to indicate that the vehicle 103 is traveling at a speed that is beyond the speed limit, the signal C (that is transmitted from the police vehicle 100 to the police station 105) can contain, for example, the specific information on the vehicle 103, its owner, the speed of the vehicle 103, the videotaped and/or photographed information of the vehicle 103, its license plate (or tag), or the like Upon receiving signal C, the police station 105 processes the information contained in the signal C. The processing of this information contained in signal C includes the processing, based on the above-discussed information contained in signal C, a traffic ticket, issuing and transmitting of such traffic ticket, either via the post office or electronically to the vehicle owner's home 110 More particularly, the information from the transmitting device 220 transmits all or part thereof the information (received by the transmitting device 220) from the radar system 200, vehicle speed processor 205, and videotaping/photographic device 210, preferably within the processing system of the police vehicle 100, to the police station 105 for processing and for issuing at least a traffic ticket, as discussed above, to the vehicle owner's home 110.

The present invention is not limited to the above-described embodiments, and various modifications in design, structural arrangement or the like may be made without departing from the scope or equivalents of the present invention.

I claim:

1. An automatic traffic ticket issuance system, comprising:
a means for detecting the speed of at least one vehicle;
a means for detecting information on the vehicle;
a means, operably coupled to the detecting means, for receiving the information from the vehicle, and for determining whether a detected speed of the vehicle is beyond a speed limit prescribed for the road on which the vehicle travels; and
a means, operably coupled to the receiving means, for transmitting the information on the vehicle, including the detected speed thereof that has surpassed the prescribed speed limit, to a processing station.

2. The system as in claim 1, wherein the processing station receives the information on the vehicle, processes the information, including the issuance of a traffic ticket and forwarding thereof to the home of the owner of the vehicle.

3. The system as in claim 1, wherein the means for detecting information on the vehicle is a radar system.

4. The system as in claim 3, wherein the means for detecting information on the vehicle includes at least one of videotaping and photographing the vehicle.

5. A method for automatically issuing at least a traffic ticket, comprising the steps of:
detecting the speed of at least one vehicle;
detecting information on the vehicle;
receiving the information from the vehicle, and determining whether a detected speed of the vehicle is beyond a speed limit prescribed for the road on which the vehicle travels; and
transmitting the information on the vehicle, including the detected speed thereof that has surpassed the prescribed speed limit, to a processing station.

6. The method as in claim 5, a processing station receives the information on the vehicle, processes the information, including the issuance of a traffic ticket and forwarding thereof to the home of the owner of the vehicle.

7. The method as in claim 5, wherein the step for detecting information on the vehicle includes the step for detecting the vehicle information with a radar system.

8. The method as in claim 7, wherein the step for detecting information on the vehicle includes at least one of videotaping and photographing the vehicle.
